(19) United States
(12) Patent Application Publication
(10) Pub. No.: US 2013/0105365 A1
(43) Pub. Date: May 2, 2013

(54) METHODS FOR CREATING HIGH PURITY STREAMS OF PLASTICS RECOVERED FROM DURABLE GOODS

(71) Applicant: MBA Polymers, Inc., Richmond, CA (US)

(72) Inventors: Brian L. Riise, San Ramon, CA (US); John Gysbers, St. Augustine, FL (US); Michael B. Biddle, Walnut Creek, CA (US)

(73) Assignee: MBA POLYMERS, INC., Richmond, CA (US)

(21) Appl. No.: 13/662,881

(22) Filed: Oct. 29, 2012

Related U.S. Application Data
(60) Provisional application No. 61/552,774, filed on Oct. 28, 2011.

(51) Int. Cl. B07C 5/00; B07C 5/34; B03D 1/02; B07C 5/04; B03C 7/00

(52) U.S. Cl. 209/127.1; 209/164; 209/659; 209/587; 209/509

(57) ABSTRACT

A process for purifying plastic from a waste stream can include separating a waste stream into two or more mixtures of flakes with each mixture containing one or more plastic types and performing an automated sorting process on the first mixture to increase the weight percentage of a plastic family in the first mixture. The separation process can include at least one process selected from the group consisting of density separation, electrostatic sorting, froth flotation, and density differential alteration. Prior to the automated sorting process, the first mixture can include at least 80% by weight of one or more plastics from the plastic family.

### CLAIM OF PRIORITY

This application claims priority under 35 USC §119(e) to U.S. Patent Application Ser. No. 61/552,774, filed on Oct. 28, 2011, the entire contents of which are hereby incorporated by reference.

### TECHNICAL FIELD

This disclosure relates to material separations, including recycling plastics from streams of waste plastics and other materials.

### BACKGROUND

Products made from or incorporating plastic are used in almost any work place or home environment. Generally, the plastics that are used to create these products are formed from virgin plastic materials. That is, the plastics are produced from petroleum and are not made from existing plastic materials. Once the products have outlived their useful lives, they are generally sent to waste disposal or a recycling plant.

Recycling plastic has a variety of benefits over creating virgin plastic from petroleum. Generally, less energy is required to manufacture an article from recycled plastic materials derived from post-consumer and post-industrial waste materials and plastic scrap (collectively referred to in this specification as “waste plastic material”), than from the comparable virgin plastic. Recycling plastic materials obviates the need for disposing of the plastic materials or product. Further, less of the earth's limited resources, such as petroleum and polymers, are used to form virgin plastic materials.

When plastic materials are sent to be recycled, the feed streams rich in plastics may be separated into multiple product and byproduct streams. Generally, the recycling processes can be applied to a variety of plastics-rich streams derived from post-industrial and post-consumer sources. These streams may include, for example, plastics from office automation equipment (printers, computers, copiers, etc.), white goods (refrigerators, washing machines, etc.), consumer electronics (televisions, video cassette recorders, stereos, etc.), automotive shredder residue (the mixed materials remaining after most of the metals have been sorted from shredded automobiles and other metal-rich products “shredded” by metal recyclers), packaging waste, household waste, building waste and industrial molding and extrusion scrap.

Different types of plastic parts are often processed into shredded plastic-rich streams. The variety of parts can vary from a single type of part from a single manufacturer up to multiple families of part types. Many variations exist, depending on at least the nature of the shredding operation. Plastics from more than one source of durable goods may be included in the mix of materials fed to a plastics recycling plant. This means that a very broad range of plastics may be included in the feed mixture. Some of the prevalent polymer types in the waste plastic materials derived from the recycling of end-of-life durable goods are acrylonitrile-butadiene-styrene (ABS), high impact polystyrene (HIPS), polypropylene (PP), polyethylene (PE) and polycarbonate (PC), and blends of PC with ABS (PC/ABS), but other polymers may also be present.

Mixtures of recycled plastic materials can also contain rubber, wood, thermosets and other non-plastic materials.

In order to create product streams suitable for the widest range of applications, it is desirable to purify the flakes such that they contain almost entirely one type of plastic and almost no non-plastic materials.

In the following, methods are described for achieving high purity streams of plastic flakes.

### SUMMARY

Methods are described for increasing the purities of plastic flake streams recovered from durable goods. In some cases, a process for purifying plastic from a waste stream can include separating a waste stream into two or more mixtures of flakes with each mixture containing one or more plastic types and performing an automated sorting process on the first mixture to increase the weight percentage of a plastic family in the first mixture. The separation process can include at least one process selected from the group consisting of density separation, electrostatic sorting, froth flotation, and density differential alteration. Prior to the automated sorting process, the first mixture can include at least 80% by weight of one or more plastics from the plastic family.

### DETAILED DESCRIPTION

This application describes methods for purifying plastic from durable-goods waste streams. In some embodiments, the purification can include removal of undesirable plastics and non-plastics from a stream of a single plastic type. In some embodiments, the purification can include removal of undesirable plastics and non-plastics from a stream of a family of two or more plastic types.

Accordingly, in the following, we describe methods, systems and devices for the purification of streams primarily containing one or more desired plastic types.

A recycling plant for the recovery of plastics from durable goods typically includes a number of process steps. For example, U.S. Pat. No. 7,802,685 describes various sequences of various process steps for the removal of non-plastics and the separation of the various plastic types from streams containing mixtures of plastics from durable goods. The methods, systems, and devices described herein can be used in sequence with or in substitution for the various process steps described in U.S. Pat. No. 7,802,685, which is hereby incorporated by reference and attached as Appendix A. These sequences of processes apply to both streams derived from durable goods and to streams of packaging materials, bottles or other mixtures rich in plastics. The process can include the use of one or more size reduction steps performed on a plastics-rich mixture from durable goods. The feed mixture can be shredded material from which some metal has been removed. The durable goods themselves can be size reduced two or more times prior to extrusion.

A mixture rich in plastic material can be processed through size reduction equipment one or more times. The size reduction steps may include rotary grinding, a hammermill, shredding, granulation, or any other size reduction processes known by those skilled in the art.

The mixture rich in plastic flakes can be processed through one or more density separation processes. These density separation processes can occur in water at a density cut point of 1.0, or in aqueous salt solutions or aqueous suspensions of solid particles with density cut points greater than 1.0, for example as described in U.S. Pat. No. 7,802,685. The plastic-rich mixture may also contain rubber, wood and other non-plastics. The flakes can range in size from around 1 mm to around 50 mm, although certain processes may work best when the particles are between about 2 mm and about 10 mm. Size reduction, in some embodiments, can precede the density separation processes. In other embodiments, size reduction can also follow the density separation process to create a final flake size between about 2 mm and about 10 mm.

The density separations may be carried out in any of the types of density separation equipment. For example, hydrocyclones can efficiently separate materials of different densities based on the high centrifugal forces present in the liquid slurry swirling inside a cyclone.

An appropriate rinsing step can be used after elevated density separations. The rinsing step may contain, for example, small water jets that are designed to rinse the majority of the salt solution or suspended particles off the materials in the plastic-rich flake mixture.

The mixtures can also be dried in a controlled manner after the density separations. Flake materials tend to adhere to surfaces if they are overly damp or wet, and this can result in poor separation performance for some of the processes described herein.

Two product streams can be recovered from each density separation process. One or both of these product streams may be further processed to recover high purity plastics. Each product from the density separation often contains two or more types of plastics and small amounts of non-plastics. Such a product therefore requires further purification steps, as described in U.S. Pat. No. 7,802,685. These purification steps typically include processes relying on a narrow surface to mass distribution which are preceded by surface to mass control operations.

After purification of the plastics by type (and also sometimes grade), the material can be melt compounded. The flake to be melt compounded can be blended prior to extrusion in order to improve product uniformity. The product from melt compounding can be pellets, sheet or other profile shape (e.g. a board).

The mechanical properties of the compounded material tend to be better if the flakes are entirely a single type of plastic. Flakes with purities substantially below 100% can require additives such as compatibilizers and impact modifiers to improve the mechanical properties such that the compounded material can compete directly with similar virgin plastics. Some “contaminating” materials can also be restricted to very low levels in some markets.

After the purification steps that rely on a narrow surface to mass distribution, the purity of a plastic flake product can still be below 100%. For example, the purity can be greater than or equal to about 80%, 85%, 90% or 95%, or 99% by weight. The product compounded from such flake mixtures may require additives such as compatibilizers and impact modifiers. These additives can add cost to the product, so increasing the purity of flakes to closer to 100% in purity can reduce costs. For example, increasing the purity from about 90% to about 97% (or greater) can reduce the additive requirements to achieve the desired mechanical properties. Selective removal of certain contaminants or plastics containing certain undesirable contaminants can also increase market applications (e.g. by removing non-melts, plastics, additives or plastics with coatings that harm the surface appearance of the plastic or which incorporate substances of concern in the plastics). In some embodiments, the purity can be increased to about 99% or greater.

After the purification steps that rely on a narrow surface to mass distribution, the purity of the product flakes can depend on a number of factors. Such factors can include the composition of the mixture fed to the purification steps as well as process parameters for the separation. If the composition varies over time, the properties of the product also vary. Because of this, it is desirable to consistently recover flakes of consistent and high purities.

To further purify flakes with purities below 100%, additional sorting steps may be necessary. Other potential sorting steps can rely on a narrow surface to mass distribution. Such steps can work to increase the purity, but any problems that prevented the separation in the first pass may persist and limit the separation in a second pass.

Another option for purifying streams with purities below 100%, but above about 80 to 85%, is sorting based on differences in reflected or absorbed electromagnetic radiation. The radiation may include visible light such that sorting is based on color, near infrared radiation such that the sorting is based on differences in spectra of the different plastics, X-rays such that the sorting is based on differences in the atomic density of the plastics, laser light, mid infrared radiation or others.

Sorting based on color may be useful when plastics or non-plastics of a given type tend to be of a particular color that is different from that of the primary plastic type. This method can be of limited use for streams with broad mixtures of colors, though, as is often the case with streams of plastics recovered from durable goods. This technique can also be useful for removal of plastic particles containing certain contaminants, such as heavy metals that are found in certain pigments in polymers. For example, such processes of sorting based on color are described in US 2011/0089086, which is hereby incorporated by reference and attached as Appendix B.

Near infrared (NIR) radiation allows the identification of flakes without carbon black or with very small amounts of carbon black. Sorting based on NIR is therefore most useful with streams containing few black flakes. NIR sorting can be used to improve the purity of streams containing mixtures of colors, but the degree of improvement and ultimate product purity is limited by the portion of flakes pigmented with carbon black. NIR sorting equipment is available from a number of companies, including Titech (Asker, Norway).

X-ray radiation is absorbed most strongly by materials with high atomic density, so differences in absorption can be used to distinguish some plastics from others. The method can be useful to distinguish flame retardant grades of plastics (which often contain brominated flame retardants) from grades without flame retardants. Sorting equipment based on X-ray transmission is available from a number of companies, including Titech (Asker, Norway).

X-ray fluorescence can also be used to identify particular elements in plastics. Plastic flakes containing heavy elements such as halogens (e.g. bromine and chlorine) or heavy metals (e.g. lead, cadmium or chromium) can be identified and ejected. Sorting equipment based on X-ray fluorescence is available from a number of companies, including BT-Wolfgang Binder GmbH (Gleisdorf, Austria).

Sorting based on the use of high speed laser spectroscopy is also possible. Each type of material may give a distinct spectral signature such that flakes not matching the spectra of the desired flake are ejected in a sorter. Such sorting equipment is available from Unisensor Sensorsysteme GmbH (Karlsruhe, Germany).

Sorting based on mid infrared radiation is also possible. For example, it is straightforward to distinguish plastic types using fourier-transform infrared (FTIR) spectroscopy. Other ranges of infrared radiation or detection methods are conceivable for rapidly distinguishing between plastic types and could be incorporated into automated sorting equipment.

In some cases, more than one type of radiation and method of measuring the reflected or absorbed radiation can be used in a single sorter. Logic (e.g., executed by a computer) can be used to determine whether materials are to be ejected based on information from the two or more measurements. Such an approach can be useful when a single type of radiation and measurement method is incapable of adequately distinguishing between certain materials. Commercial equipment including combinations of measurements is available from several suppliers of automated sorting equipment.

Processing of the image of reflected radiation can also include analyzing the shape of the image. Particles of a certain shape or aspect ratio can be typical for a given type of material, and this image processing can be used either alone or in combination with another measurement method (or combination of methods) to decide whether or not to eject the particle.

Sorting equipment exists for flakes in the particle size range of interest (between about 2 mm and about 10 mm). Sliding chute sorters, where flakes slide down the chutes and are analyzed and ejected (by air) after the end of the chute, can be used for this size range. In certain embodiments, the percentage of target flakes in the mixture is at least 80 weight percent in order to reduce the number of particles improperly ejected. For example, air blasts may cover a larger area than necessary to eject the particular defect flake and thus also eject target flakes.

Such sorting equipment is ideally suited to products after the purification steps relying on a narrow surface to mass distribution, since the purities of such mixtures can be between about 80% and 99% by weight. The streams can also be between about 90% and 95% by weight.

Depending on the specific method for flake identification, the flake streams with purities between about 80% and 99% by weight can be purified to between about 95% and purities approaching 100 percent by weight. For example, it is possible to purity to 99.9%, 99.99%, and even 99.999% by weight under certain circumstances. Similarly, streams with purities starting between about 90% and 95% by weight can also be purified to between about 95% and purities approaching 100% by weight.

For a given detection method, we expect the ultimate purity after sorting to be only slightly dependent on the composition of the flakes after the purification steps relying on a narrow surface to mass distribution. For example, a stream with purities varying from about 90 to 95% by weight might achieve purities between about 98% and 99% by weight after sorting.

Processes to prepare flake mixtures with purities greater than 80% by weight are not limited to purification steps relying on a narrow surface to mass distribution. Processes such as density separation can create streams of a single plastic type with a purity greater than 80%, for example. Such density separation processes can in some cases be improved by having a more narrow surface to mass distribution, but it is not always necessary to perform a surface to mass control operation.

In order to achieve an 80% purity, surface to mass control operations are not always needed to enable separation using triboelectrostatic separation, froth floatation or density differential alteration. These processes rely on surface to mass control operations for best performance, but these processes may work well enough to create 80% or greater purity streams without surface to mass control processes.

The use of automated sorting is not limited to plastic streams after purification steps (e.g. processes relying on a narrow surface to mass distribution) that increase the plastic purity to 80% or greater. Such automated sorting can also be applied to remove small (i.e. less than 20% total) amounts of certain plastic and non-plastic contaminants from mixtures recovered prior to the purification steps. For example, a mixture containing mostly a group of two or more desired plastics (a plastic family) but less than about 20% by weight of other plastics and/or non-melts (such as rubber and wood) can be processed to sort out the other plastics and/or non-melts. Such sorting would result in a stream containing primarily the desired plastics with only small amounts (e.g. less than about 0.1% to 5% by weight) of the other plastics and/or rubber. The resulting stream can be more easily separated using purification steps (e.g. processes relying on a narrow surface to mass distribution). Prophetic examples 2 and 3 describe some potential uses of automated sorting to purify plastic families.

The use of automated sorting is not limited to streams where the particle size is between about 2 mm and about 10 mm. Larger particles can be sorted using automated sorting equipment. Sorting of larger particles can be done using belt-style sorters where the materials are characterized while sitting on the belt and defect particles are ejected pneumatically or with paddles after the material stream leaves the end of the belt.

Automatic sorting of larger particles also enables the sorting of mixtures with larger portions of the material to be ejected. Such sorters can allow for ejection of 50% or more of the particles in the mixture. The throughput, however, may need to be adjusted to allow for the ejection of so many particles without ejecting to many of the desired particles. Such sorting can be useful for processing of shredder residue derived from waste electronics, shredder residue from end-of-life vehicles, mixed rigid plastic packaging or other complex plastic-rich waste or scrap streams, where the majority of the particles in the stream might not be the most prevalent plastics targeted for recovery. Mixed rigid plastics are rigid plastics (not films) from normal household waste and can include things like containers (e.g., beverage/food/shampoo/detergent bottles, tubs, jugs (as in milk jugs), pails, bins, and crates), toys, and plastic furniture.

Automatic sorting can be used as a process to increase the purity of the plastic “family” up to the purity of 80% or greater that is required for purification. Such a process can result in a significant amount of incorrectly ejected plastics from the desired plastic family, but these can be recovered by re-circulation or by multiple sorting steps. Prophetic example 4 describes such a sequence of processes that could be used to create purified product streams.

Automatic sorting can be used to sort out minority plastics or families of plastics that are targeted for recovery and will be separated in subsequent sorting. If 20% by weight or less of the one or more plastics in the targeted family are present in a mixture, the plastics in the family can be ejected from the mixture using automatic sorting methods. Prophetic example 5 describes how this method could be used to isolate target plastics that are only a minority of a feed mixture that is rich in non-plastics.

Automatic sorting is not limited to binary sorts. Automatic sorters can include separate ejector banks that shoot in opposite directions. There can therefore be streams created when ejectors are not fired, when ejectors in one direction are fired and when ejectors in the other direction are fired. Additionally, multiple sorters ejecting different types of particles could be operated in series to collect three or more sorts.

Automated sorting is also valuable in that it can remove flakes that contain even small amounts of paint or labels. Paint or labels may in some cases be difficult to otherwise remove from the mixture, but their presence can have an adverse effect on product properties. If the detection method used for the automated sorting is able to distinguish the paint or labels from the plastic, flakes contaminated with paint or labels can be ejected.

Automated sorting is valuable in that it can be used to remove rubber or other non-melts from the plastic flakes. Rubber and other non-melts can be difficult to remove completely using other methods and can end up as small defects in finished products even after fine melt filtration is used to screen out rubber (and other non-melt) particles smaller than about 100 microns. Using an automated sorting method that is capable of distinguishing rubber from the desired plastic material is advantageous because it can reduce the amount of rubber to very low levels.

### PROPHETIC EXAMPLES

The following prophetic examples show potential uses of the use of automated sorting to improve the purity of plastic streams derived from durable goods.

### Prophetic Example 1

### Purification of an ABS Flake Stream

Consider a hypothetical stream of mostly ABS flakes that have been recovered from a mixture of waste electronics. The composition of the stream, which also includes various other plastics and non-plastics is shown in Table 1.1.

This stream is then processed using an automated sorter that is capable of identifying and ejecting all flakes in the mixture. The vast majority of flakes that are not identified as ABS are ejected. The resulting product composition is also shown in Table 1.1.

TABLE 1.1
Composition of hypothetical ABS stream before and
after automated sorting to purify the ABS

| | Composition (wt. %) | |
|---|---|---|
| Component | Before Sorting | After Sorting |
| ABS | 95.0% | >99% |
| HIPS | 4.0% | <1% |
| PC/ABS | 0.5% | <0.1% |
| PA | 0.3% | <0.05% |
| rubber | 0.2% | <0.05% |

### Prophetic Example 2

### Removal of Filled PP from a Mixture of ABS and HIPS

Consider a hypothetical stream of mostly ABS and HIPS flakes hypothetically recovered by density separation steps from a mixture of waste electronics. The stream also contains a small amount of filled PP which happens to be in the same density range as the ABS and HIPS. The composition of the stream, which also includes various other plastics and non-plastics is shown in Table 2.1.

This stream is then processed using an automated sorter that is capable of identifying and ejecting all flakes in the mixture. The vast majority of flakes that are not identified as ABS or HIPS are ejected, creating a binary mixture that is more easily separated using purification steps relying on a narrow surface to mass distribution. The resulting product composition is also shown in Table 2.1.

TABLE 2.1
Composition of hypothetical ABS/HIPS stream before and
after automated sorting to remove other plastics and non-plastics

| | Composition (wt. %) | |
|---|---|---|
| Component | Before Sorting | After Sorting |
| ABS | 46.0% | >49% |
| HIPS | 46.0% | >49% |
| Filled PP | 6.0% | <1% |
| PC/ABS | 1.0% | <0.1% |
| PA | 0.6% | <0.05% |
| wood | 0.2% | <0.05% |
| rubber | 0.2% | <0.05% |

### Prophetic Example 3

### Removal of Rubber and Foam From a Stream Containing Large Particles

Consider a hypothetical plastic-rich stream of shredded material from end-of-life vehicles. The stream has been upgraded from the raw shredder residue and now contains mostly plastic with smaller amounts of rubber, foam and wood. The composition of the stream, which also includes various other plastics and non-plastics is shown in Table 3.1.

This stream is then processed using an automated sorter that is capable of identifying and ejecting all flakes in the mixture. The majority of flakes that are not identified as ABS, HIPS, PP, Filled PP or PE (the plastic family) are ejected, creating a mixture that is enriched in target plastics and that can be separated more easily in subsequent processing steps. The resulting product composition is also shown in Table 3.1.

TABLE 3.1
Composition of hypothetical shredded plastic stream before and after
automated sorting to remove other non-target plastics and non-plastics

| | Composition (wt. %) | |
|---|---|---|
| Component | Before Sorting | After Sorting |
| Target Plastics (ABS, HIPS, | 80% | >95% |
| PP, Filled PP and PE) | | |
| Non-target plastics (PA, | 6% | <1% |
| PC/ABS, others) | | |
| foam | 2% | <1% |
| wood | 6% | <2% |
| rubber | 6% | <2% |

### Prophetic Example 4

### Purification of an ABS and HIPS from a Mixture of Electronics Shredder Residue

Consider a hypothetical mixture of primarily 10-50 mm diameter particles of electronics shredder residue (ESR) containing 25% ABS, 25% HIPS, 40% other plastics and 10% non-plastics (i.e. rubber, wood and foam).

As a first step, the ESR is sorted on a belt sorter to remove the non-plastics. Such a sort can be very efficient (i.e. resulting in very little loss of ABS and HIPS) because only 10% of the stream is the material to be ejected. The product after such a sort can contain very little of the non-plastic material. A hypothetical composition is provided in Table 4.1.

The mainly plastic product can then be sorted on a second belt sorter to remove most of the other plastics and perhaps some of the remaining non-plastics. The resulting product can include about 94% combined ABS and HIPS and about 6% combined other plastics and non-plastics, as shown in Table 4.1.

The mainly ABS and HIPS stream after removal of “other plastics” can be sorted using a belt sorter by ejecting HIPS flakes. The resulting ABS-rich and HIPS-rich streams can have purities of about 80 to 85%, so can be sorted for purification in a final step.

TABLE 4.1
Compositions of Product streams for the
recovery of ABS and HIPS from ESR

| | Compositions of streams (weight %) | | | | |
|---|---|---|---|---|---|
| | | Product | Product | | |
| | | after | after | ABS-rich | HIPS-rich |
| | | removal | removal | stream | stream |
| | | of non- | of “other | after ABS/ | after ABS/ |
| Component | Feed | plastics | plastics” | HIPS sort | HIPS sort |
| ABS | 25% | 27% | 47% | 85% | 18% |
| HIPS | 25% | 27% | 47% | 5% | 80% |
| Other plastics | 40% | 44% | 5% | 9% | 2% |
| Non-plastics | 10% | 1% | <1% | 1% | <1% |

### Prophetic Example 5

### Isolation of a Plastics Family by Ejection from a Complex Mixture

Consider a hypothetical mixture of primarily 10-50 mm diameter particles of automotive shredder residue (ASR) containing 25% rubber, 25% foam, 20% wood, 15% non-target plastics and 10% target plastics (ABS, HIPS, PP and PE).

The ASR is sorted on a belt sorter to eject the family of target plastics (ABS, HIPS, PP and PE) from the remaining materials. Such a sort can result in a portion of the non-target material being mistakenly ejected into the stream along with the target plastics, but this intermediate stream can be further sorted to eject the non-target materials. Hypothetical compositions of the feed, intermediate product and product (target plastic) stream are provided in Table 5.1.

The target plastic product can then be sorted using automatic sorting or other methods useful for the enrichment and purification of plastics.

TABLE 5.1
Compositions of streams for the recovery of target plastics from ASR

| | Compositions of streams (weight %) | | |
|---|---|---|---|
| | | Reject Material from | Product after ejecting |
| | Feed | Automatic sort #1 | non-target materials |
| Target plastics (ABS, | 15% | 67% | 94% |
| HIPS, PP, PE) | | | |
| Other plastics | 15% | 6% | 1% |
| Rubber, foam and | 70% | 27% | 5% |
| wood | | | |

1. A process for purifying plastic from a waste stream comprising:
separating a waste stream into two or more mixtures of flakes, wherein the separation process comprises at least one process selected from the group consisting of density separation, electrostatic sorting, froth flotation, and density differential alteration, wherein each mixture contains one or more plastic types, wherein a first mixture comprises at least 80% by weight of one or more plastics from a plastic family; and
performing an automated sorting process on the first mixture to increase the weight percentage of the plastic family in the first mixture.

2. The process according to claim 1, wherein the waste steam comprises durable goods, mixed rigids, or a combination thereof.

3. The process according to claim 1, wherein the automated sorting process increases the weight percentage of the plastic family in the first mixture to at least 95% by weight.

4. The process according to claim 1, wherein the automated sorting is performed on a sliding chute style sorter.

5. The process according to claim 1, wherein the automated sorting is accomplished by detecting differences in reflected, scattered and/or absorbed electromagnetic radiation from different materials in the first mixture.

6. The process according to claim 1, wherein the undesirable plastics are plastics that are different from the plastic family in the first mixture.

7. The process according to claim 1, wherein the first mixture prior to automated sorting includes greater than 85% by weight of the plastic family.

8. The process according to claim 1, wherein the plastic family is polyolefins.

9. The process according to claim 1, wherein the plastic family comprises two or more plastics from the group including ABS, HIPS, polyethylene, polypropylene, filled polypropylene, PC and blends of PC and ABS.

10. The process according to claim 1, wherein the first mixture comprises at least 80% by a single type of plastic prior to the automatic sorting process and the automatic sorting process increases the weight percentage of the single type of plastic in the first mixture.

11. The process according to claim 10, wherein the single type of plastic is ABS, PC, or HIPS.

12. The process according to claim 10, wherein the single type of plastic is polyethylene, polypropylene, or filled polypropylene.

13. The process according to claim 10, wherein the single type of plastic is a blend of PC and ABS.

14. The process according to claim 1, wherein the flakes removed by the automated sorting include plastics different from those in the plastic family.

15. The process according to claim 1, wherein the flakes removed by the automated sorting include non-plastic materials.

16. The process according to claim 15, wherein the non-plastic material includes rubber, wood, foam, textiles or a combination thereof.

17. The process according to claim 1, wherein the flakes removed by the sorting include plastics covered with paint, labels, or coatings.

18. The process according to claim 1, wherein the durable-goods waste stream comprises plastics from office automation equipment, white goods, consumer electronics, automotive shredder residue, packaging waste, household waste, building waste, and/or industrial molding and extrusion scrap.

19. A process for reducing the content of undesirable plastic and non-plastic materials in mixtures of plastics from durable goods comprising:
performing an automated sorting process on a mixture containing flakes of one or more plastic types, wherein the portion of flakes in the mixture of one or more plastic types is greater than 80% by weight prior to the automated sorting process and the automated sorting process increases the weight percentage of the one or more plastic types in the mixture.

20. The process according to claim 19, wherein the flakes in the mixtures have an average particle diameter of less than 10 millimeters.

21. A process for producing a stream of purified plastic from a mixture of one or more target plastics, one or more undesirable plastics, and/or one or more non-plastic materials comprising:
performing an automated sorting process on a mixture containing flakes of one or more plastic types and optionally non-plastic materials, wherein the portion of flakes in the mixture of one or more target plastic types is less than 20% by weight prior to the automated sorting process and the automated sorting process removes flakes from the mixture to produce a second mixture of the removed flakes having at least 20% by weight of the one or more target plastic types.

22. The process according to claim 21, wherein the flakes in the mixtures have an average particle diameter of less than 10 millimeters.

23. The process according to claim 21, wherein the second mixture of the removed flakes has at least 50% by weight of the one or more target plastic types.

24. The process according to claim 21, further comprising performing a second automated sorting process on the second mixture to increases the weight percentage of the one or more target plastic types to be greater than 80% by weight.

25. The process according to claim 24, wherein the mixture comprises rubber, foam, wood, non-target plastics, and at least 5 weight percent of the one or more target plastic types, wherein the one or more target plastic types are selected from the group consisting of ABS, HIPS, PP, PE, and combinations thereof.
